(19) United States
(12) Patent Application Publication
(10) Pub. No.: US 2005/0162565 A1
(43) Pub. Date: Jul. 28, 2005

(54) Slow motion processing of digital video data

(75) Inventors: Lu Zhen, Hangzhou (CN); Yushan Huang, Hangzhou (CN); Donghui Wu, Fremont, CA (US); Lingxiang Zhou, Fremont, CA (US)

Correspondence Address: PATENT LAW GROUP LLP, 2635 NORTH FIRST STREET, SUITE 223, SAN JOSE, CA, 95134, US

(73) Assignee: ArcSoft, Inc.

(21) Appl. No.: 10/748,371

(22) Filed: Dec. 29, 2003

(51) Int. Cl. H04N 9/64

(52) U.S. Cl. 348/700

(57) ABSTRACT

A method includes (1) generating a first image pyramid of a first image, (2) generating a second image pyramid of a second image, (3) warping a first level image of the first image pyramid with a motion field, (4) determining a residual motion field from the warped first level image of the first image pyramid and a corresponding first level image of the second image pyramid, and (5) if the residual motion field is not less than a threshold, adding the residual motion field to the motion field and repeating steps (3) and (4).

### FIELD OF INVENTION

This invention relates to a method for generating a slow motion effect in a video.

### DESCRIPTION OF RELATED ART

In order to enhance the visual effect of a motion scene, slow motion processing can construct and insert new intermediate frames between each pair of original frames. During playback, the processed video produces a “slow motion” effect to the viewers.

It is well known that simple frame reconstruction techniques such as frame repetition or linear interpolation introduce annoying artifacts. Frame repetition generates jerky object motions because object movements are simply not considered and thus not accounted for. Linear interpolation by temporal filtering exhibits blurring in moving areas because object motions are not considered and pixel values in different object regions used in the interpolation result in the blurring in object region boundaries. Object motion must be compensated in order to remove these artifacts.

Motion compensated temporal interpolation (MCTI) techniques can be used in slow motion processing of digital video data to construct new intermediate frames with considerable less artifacts. Motion estimation and compensation is a powerful means of exploiting the temporal redundancy contained in video sequences. This means is widely used in most video applications, such as video coding, de-interlacing, de-noising, de-bluring, etc. In motion compensated temporal interpolation (MCTI), the principal idea is to reconstruct all pixels at a certain time instant of their motion trajectory. An accurate interpolation requires the estimation of “true” (i.e., actual) motion vectors.

Many motion estimation techniques have been investigated. Block matching method is the most popular one, especially in video coding applications. The main advantages are its simplicity, low computational complexity, and low overhead. However, block matching produces inaccurate motion field that are piecewise constant and are not usually representative of the true motion. Video coders employ this crude motion estimation method in order to keep the bit-overhead low. The interpolated frames usually contain severe blocking artifacts and are visually inadequate, thereby necessitating the encoding and transmission of residuals for the B-frame in MPEG standard. However, in slow motion processing, motion estimates that are accurate and close to the “true” motion are expected. This is because prediction residuals are not available in this case.

Thus, what is needed is a method for producing a slow motion effect that addresses the disadvantages described above.

### BRIEF DESCRIPTION OF THE DRAWINGS

FIG. 1 illustrates a method for generating slow motion effect in one embodiment of the invention.

FIG. 2 illustrates an image pyramid for generating slow motion effect in one embodiment of the invention.

FIG. 3 illustrates a pyramidal method for estimating motion in one embodiment of the invention.

FIG. 4 illustrates an iterated registration method for estimating motion in one embodiment of the invention.

FIG. 5 illustrates a method for generating an intermediate frame from a motion field between two consecutive frames in one embodiment of the invention.

FIG. 6 is a flowchart of a method for generating a slow motion effect in one embodiment of the invention.

Use of the same reference numbers in different figures indicates similar or identical elements.

### SUMMARY

In one embodiment of the invention, a method includes (1) generating a first image pyramid of a first image, (2) generating a second image pyramid of a second image, (3) warping a first level image of the first image pyramid with a motion field, (4) determining a residual motion field from the warped first level image of the first image pyramid and a corresponding first level image of the second image pyramid, and (5) if the residual motion field is not less than a threshold, adding the residual motion field to the motion field and repeating steps (3) and (4).

### DETAILED DESCRIPTION

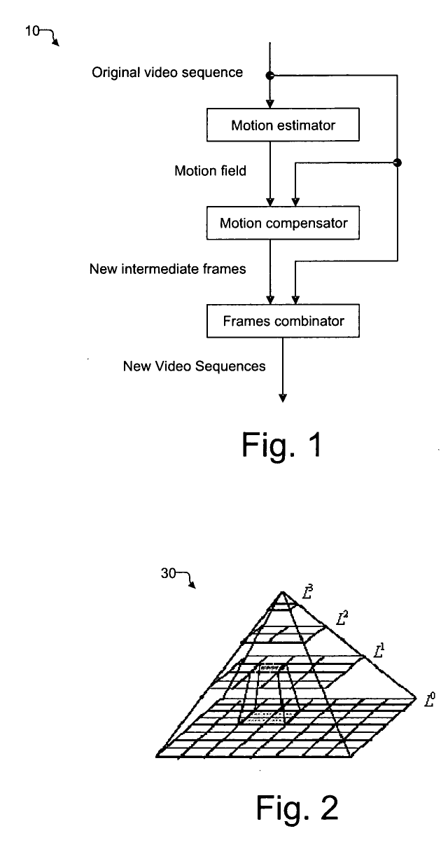

In accordance with the invention, a robust and accurate motion compensated temporal interpolation (MCTI) technique is applied in slow motion processing of digital video data to construct new intermediate frames with considerable less artifacts. As shown in FIG. 1, the slow motion processing 10 is divided into two stages: motion estimation and motion compensation. An accurate and dense motion field can be determined from each pair of consecutive frames in the original sequence. With the motion field, pixels in the original frame can be moved to appropriate locations along the motion trajectories to form a new intermediate frame. The new slow motion processed video is then formed by inserting the new intermediate frames between the original frames.

In one embodiment of the invention, the motion estimation algorithm disclosed by Horn and Schunck is used to determine a motion field between frames. B. K. P Horn, B. G. Schunck, “Determining Optical Flow,” Massachusetts Institute of Technology Artificial Intelligence Memo No. 572, April 1980. As a gradient based motion estimation method, the Horn and Schunck (HS) algorithm does not properly handle large displacement due to a linear Taylor series approximation used in the algorithm. Two modifications to the basic HS algorithm are introduced in accordance with the invention. One modification is the use of multi-resolution measurements from an image pyramid. The other modification is the use of iterated registration in motion field computation at each level of the image pyramid.

Pyramidal Motion Estimation Algorithm

In one embodiment of the invention, a coarse-to-fine strategy is used in a pyramidal motion estimation algorithm. Two image pyramids of the two frames, between which the motion field is to be determined, are constructed by successive low-pass filtering and sub-sampling. In one embodiment, the coding algorithm disclosed by Burt and Adelson is used to construct Laplacian image pyramids of the two frames. Peter J. Burt and Edward H. Adelson, “The Laplacian Pyramid as a Compact Image Code,” IEEE Transactions on Communications, Vol. Com-31, No. 4, April 1983. Low resolution motion can then be estimated reliably at the coarse level of the image pyramid. However, the loss of high frequency components makes it difficult to estimate high resolution motion.

A possible remedy consists in first passing the coarse motion field to the next finer level, and then using the coarse motion field as an initial guess for the motion field at the next finer level. Specifically, the coarse motion field is used to warp (to motion compensate) one of the two frames in the next finer level (e.g., by linearly interpolating the coarse motion field to provide a motion vector for each pixel in the next level). At the next finer level, the residual motion between the two frames is now smaller. Thus, the high frequency components can now be used to more reliably estimate fine corrections (motion field refinements) to the coarse motion field. The corrected motion field can then be passed from level to level until the finest level.

FIG. 2 illustrates an image pyramid 30 having iₘₐₓ (e.g., 3) number of levels in one embodiment. The motion estimation begins at the highest level Lⁱ^{ₘₐₓ}, where a coarse motion field dⁱ^{ₘₐₓ} is obtained using an iterative motion estimator. The iterative motion estimation algorithm is detailed in the next section. The coarse motion field dⁱ^{ₘₐₓ} is then propagated to next finer level Lⁱ^{ₘₐₓ}⁻¹ in as an initial guess for the motion field in the iterative motion estimation at level Lⁱ^{ₘₐₓ}⁻¹. As shown in FIG. 3, at each pyramid level Lⁱ of frames Iₜ₋₁ and Iₜ, the motion field dⁱ⁺¹ is propagated from the coarser level Lⁱ⁺¹ and used as an initial guess for the motion field. Given that initial guess, the refined motion field is computed by the iterative motion estimation, and the result is propagated to the next finer level Lⁱ⁻¹, and so on to level L⁰, which represents the original frame. The final result d⁰ is the desired motion field between frames Iₜ₋₁ and Iₜ.

Iterative Motion Estimation Algorithm

When the motion between frames Iₜ₋₁ and Iₜ is very large, the pyramidal motion estimator will require many levels in the image pyramid. This can lead to over-smoothing at the coarse levels that cannot be corrected at the finer levels, since the HS algorithm can only estimate small corrections. In this situation, an iterated registration method disclosed by Lucas and Kanade is added to the HS algorithm at each level of the image pyramid. B. Lucas, T. Kanade, “An Iterative Image Registration Technique with an Application to Stereo Vision,” In Proceedings of the 7^{th} International Joint Conference on Artificial Intelligence, 1981. The coarse-to-fine strategy is used again here. The coarse motion field is used to warp one of the two frames, and the smaller residual motion between the two frames (one warped and the other unchanged) is computed using the HS algorithm, and added to the coarse motion field as a refinement. The warping and the computing the residual motion can be repeated to get a more refined motion field at each level of the image pyramid.

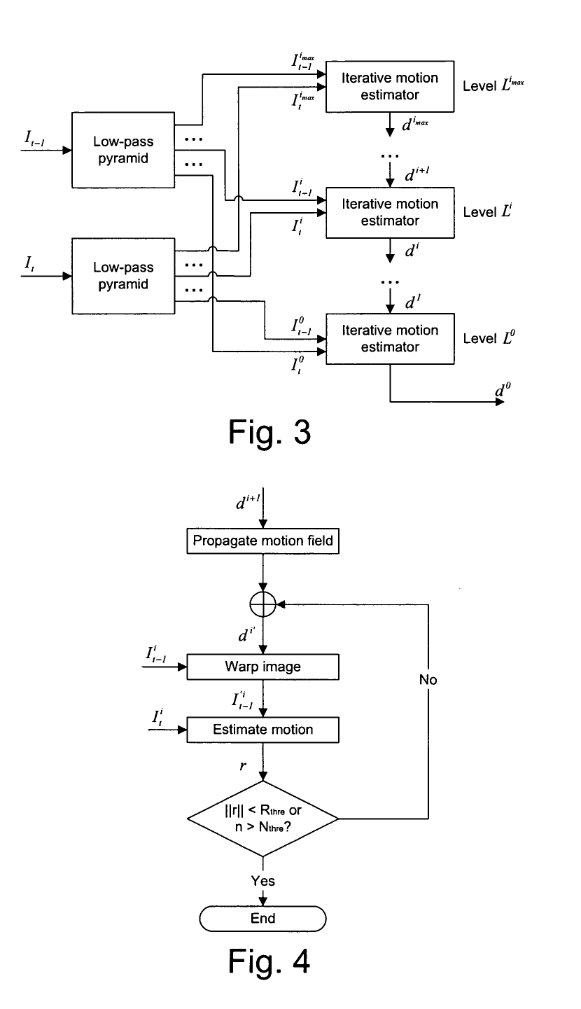

The difference to the coarse-to-fine strategy used in pyramidal motion estimation algorithm described in the last section is that the motion field is passed within the level, not from coarse to finer levels. As shown in FIG. 4, at level Lⁱ, the coarse motion field dⁱ⁺¹ of level Lⁱ⁺¹ is propagated and used as an initial guess d^{i′} for the motion field. Frame Iⁱₜ₋₁ is then warped to I^{′t}ₜ₋₁ by the initial guess d^{i′}. Using the HS algorithm, the residual motion r between warped frame I^{′t}ₜ₋₁ and frame Iⁱₜ is determined, and added to the initial guess d^{i′} as a refinement. The refined motion field is then used as initial guess again. The procedures of warping frame, the HS motion estimation, the motion field refining are carried out recursively, until the norm of the residual motion field r is less than a predefined threshold Rₜₕᵣₑ, or the iterative number n is more than a predefined threshold Nₜₕᵣₑ. The final result of the motion field at level Lⁱ is propagated to next finer level Lⁱ⁺¹ as the initial guess of that level according to the pyramidal motion estimation algorithm described in last section.

The above described motion estimation method combines the iterated registration method with the pyramidal motion estimation method. This method, hereafter referred as iterative pyramidal motion estimation (IPME), has two major advantages. Firstly, lesser number of levels in the image pyramid will be needed since larger motion at each level can now be track. Secondly, the coarse motion estimation errors propagated to the finer levels can be recovered. At the same time, IPME algorithm has faster convergence property than that of the HS algorithm, and it is more efficient than the HS algorithm.

Motion Compensation

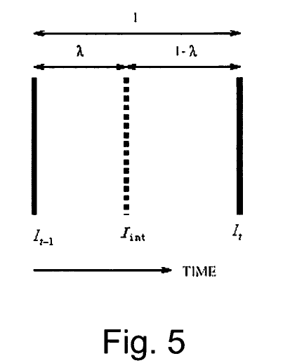

After motion estimation between frames Iₜ₋₁ and Iₜ, a dense and accurate motion field d, which is the final result of motion field d⁰ at level L⁰, is determined. With the motion vectors in motion field d, a matching pixel in frame Iₜ is found for each pixel in frame Iₜ₋₁. Then, along the motion trajectory, the matched pixels pair is moved to a proper pixel location on the intermediate frame Iᵢₙₜ as shown in FIG. 5. In FIG. 5, λ is a parameter representing the location on the motion trajectory from frame Iₜ₋₁ to frame Iₜ, where λ ranges from 0 (at a corresponding pixel location in frame Iₜ₋₁) to 1 (at a corresponding pixel location in frame Iₜ). Thus, a motion vector is assigned that pixel location on the frame Iᵢₙₜ.

Most pixels in frame Iᵢₙₜ can be assigned one motion vector. A few pixels in frame Iᵢₙₜ will have multiple assignments. These can be handled by averaging. A few pixels in frame Iᵢₙₜ may receive no assignment. For these pixels, the motion vectors of the neighboring pixels are fitted to an affine translation using least-squares methods. Then the motion vectors for these pixels are computed by the fitted affine translation.

After the assignment of the motion vectors, the value of each pixel in frame Iᵢₙₜ can be computed from the matched pixels pair. The color value of each pixel in frame Iᵢₙₜ is computed by linear interpolation of the matched pixel pair according to location parameter λ.

Exemplary Flowchart

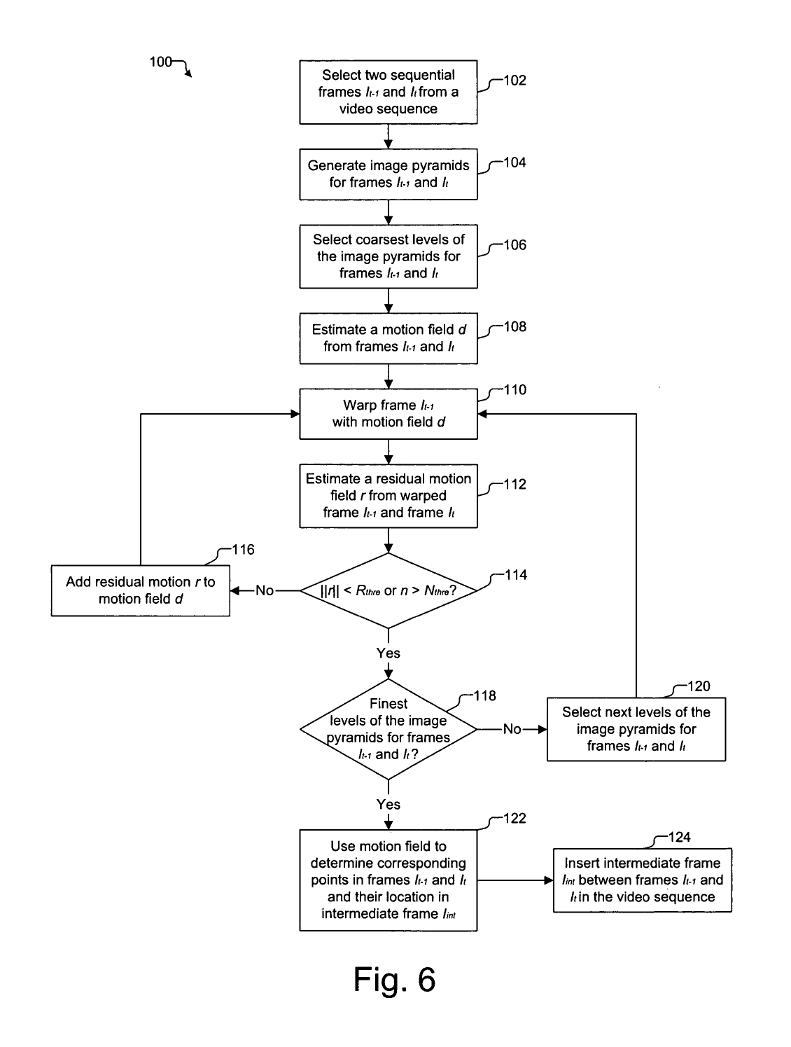

FIG. 6 illustrates a flowchart of a method 100 for implementing the motion estimation and motion compensation described above in one embodiment of the invention. Method 100 can be used to generate an intermediate frame Iᵢₙₜ between frames Iₜ₋₁ and Iₜ. When method 100 is performed to an entire video sequence, a slow motion effect is achieved when the video sequence is played back. Method 100 can be implemented with software on a computer or any equivalents thereof.

In step 102, the computer selects two sequential frames Iₜ₋₁ and Iₜ from a video sequence.

In step 104, the computer generates image pyramids of frames Iₜ₋₁ and Iₜ. In one embodiment, the computer generates Laplacian image pyramids as disclosed by Burt and Adelson.

In step 106, the computer selects images at the coarsest level (Lⁱ^{ₘₐₓ}) of the image pyramids for frames Iₜ₋₁ and Iₜ.

In step 108, the computer estimates a motion field d between frames Iₜ₋₁ and Iₜ from their top levels images. In one embodiment, the computer determines motion field d going from frame Iₜ₋₁ to frame Iₜ. In one embodiment, the computer estimates the motion field d using the HS algorithm as disclosed by Horn and Schunck.

In step 110, the computer warps frame Iₜ₋₁ at the current image level with motion field d to form a warped frame Iₜ₋₁.

In step 112, the computer estimates a motion field r (hereafter “residual motion field r”) going from warped frame Iₜ₋₁ to frame Iₜ at the current image level. In one embodiment, the computer estimates residual motion field r using the HS algorithm as disclosed by Horn and Schunck.

In step 114, the computer determines if the norm of residual motion field r (i.e., ∥r∥) is less than a threshold Rₜₕᵣₑ or if an iterative number n of times through the loop consisting of steps 110, 112, 114, and 116 is greater than a threshold Nₜₕᵣₑ. If none of these conditions is true, then step 114 is followed by step 116. Otherwise step 114 is followed by step 118.

In step 116, the computer adds residual motion field r to motion field d. Step 116 is followed by step 110 and this loop repeats to further refine motion field d.

In step 118, the computer determines if the current iteration has processed the finest level (L₀) of the image pyramids. If not, then step 118 is followed by step 120. Otherwise step 118 is followed by step 122.

In step 120, the computer selects corresponding images at the next finer level of the image pyramids for frames Iₜ₋₁ and Iₜ. Step 120 is followed by step 110 and method 100 repeats until all the levels of the image pyramids have been processed.

In step 122, the computer generates intermediate frame Iᵢₙₜ from motion field d.

In step 124, the computer inserts intermediate frame Iᵢₙₜ between frames Iₜ₋₁ and Iₜ in the video sequence.

### CONCLUSIONS

After the procedures of motion estimation and motion compensation for each pair of consecutive frames in the original video sequence, one or more new intermediate frames can be generated and inserted into the sequence. A new video sequence with increased temporal resolution is achieved. It will exhibit slow motion effect during playback at the same frame rate as the original video sequence.

On the other hand, if the processed video is played in the same time length as the original video sequence, the frame rate is up-converted and a “fast motion” effect is created. This invention can also be used in other applications of video data, like coding, de-interlacing, de-bluring, de-noising, etc.

Various other adaptations and combinations of features of the embodiments disclosed are within the scope of the invention. Numerous embodiments are encompassed by the following claims.

1. A method, comprising:
(1) warping a first level image of the first image pyramid with a motion field;
(2) determining a residual motion field from the warped first level image of the first image pyramid and a corresponding first level image of the second image pyramid;
(3) if the residual motion field is not less than a threshold, adding the residual motion field to the motion field and repeating steps (1) and (2); and
(4) if the residual motion field is less than the threshold:
(a) warping a second level image of the first image pyramid with the motion field;
(b) determining a second residual motion field from the warped second level image of the first image pyramid and a corresponding second level image of the second image pyramid; and
(c) if the second residual motion field is not less than a threshold, adding the second residual motion to the motion field and repeating steps (4)(a) and (4)(b).

2. The method of claim 1, prior to step (1), further comprising:
generating the first image pyramid of the first image; and
generating the second image pyramid of the second image.

3. The method of claim 1, prior to step (1), further comprising determining the motion field from the first level image of the first image pyramid and the corresponding first level image of the second image pyramid.

4. The method of claim 1, wherein said generating a first image pyramid and said generating a second image pyramid comprises generating a first Laplacian pyramid of the first image and generating a second Laplacian pyramid of the second image.

5. The method of claim 2, wherein said determining a motion field and said determining a residual motion field comprises applying a Horn and Schunck motion estimation algorithm.

6. The method of claim 1, further comprising:
(4)(d) if the second residual motion field is less than the threshold, generating an intermediate image between the first and the second image from the motion field.

7. The method of claim 6, wherein said generating an intermediate image comprises:
determining a pair of corresponding points in the first and the second image from a motion vector in the motion field;
determining a value of a corresponding point in the intermediate image from the values of the pair of corresponding points;
determining a position of the corresponding point in the intermediate image from the motion vector; and
repeating said determining a pair of corresponding points, said determining a value of a corresponding point, and said determining a position of the corresponding point for remainder of motion vectors in the motion field.

8. A method, comprising:
(1) generating a first image pyramid of a first image;
(2) generating a second image pyramid of a second image;
(3) determining a motion field from a first level image of the first image pyramid and a corresponding first level image of the second image pyramid.
(4) warping the first level image of the first image pyramid with the motion field;
(5) determining a first residual motion field from the warped first level image of the first image pyramid and the corresponding first level image of the second image pyramid;
(6) if the first residual motion field is not less than a threshold, adding the residual motion field to the motion field and repeating steps (4) and (5);
(7) if the first residual motion field is less than a threshold:
(a) warping a second level image of the first image pyramid with the motion field;
(b) determining a second residual motion field from the warped second level image of the first image pyramid and a corresponding second level image of the second image pyramid; and
(c) if the second residual motion field is not less than a threshold, adding the second residual motion to the motion field and repeating steps (7)(a) and (7)(b).
